(19) United States
(12) Patent Application Publication
(10) Pub. No.: US 2007/0193786 A1
(43) Pub. Date: Aug. 23, 2007

(54) Item of Luggage with Scales

(76) Inventors: Birgit Pohl, Paderborn (DE); Jurgen Pohl, Paderborn (DE)

Correspondence Address: Fulbright & Jaworski L.L.P.;Fulbright Tower, Suite 5100, 1301 McKinney, Houston, TX, 77010-3095, US

(21) Appl. No.: 11/458,517

(22) Filed: Jul. 19, 2006

(30) Foreign Application Priority Data
Feb. 21, 2006 (DE) 10 2006 007 946.0

(51) Int. Cl. G01G 19/40

(52) U.S. Cl. 177/25.15

(57) ABSTRACT

The invention is directed to an item of luggage having scales with an associated weight outputting means for outputting the weight thereof. The scales having a load-bearing part, which is rigidly joined to the item of luggage and a free slide which can be displaced relative to the item of luggage.

### CROSS-REFERENCE TO RELATED APPLICATIONS

This application claims priority to DE 10 2006 007 946.0 filed Feb. 21, 2006.

### TECHNICAL FIELD

An item of luggage, such as a holdall, bag, suitcase, school satchel or a rucksack, can be used to transport a variety of articles.

### BACKGROUND OF THE INVENTION

In some cases, it is advantageous to know the weight of the item of luggage. One example of this is travelling by aeroplane, where the item of luggage must not exceed a prescribed weight limit. Another example is a child's school satchel, which should not exceed a certain weight, in order to avoid malformations of the child's skeletal structure.

In order to measure the weight of the item of luggage in these cases, it is typical to place the item of luggage on bathroom scales.

Weighing the item of luggage using bathroom scales is difficult, however, if the item of luggage is very large, since the item of luggage will as a rule be left with one end in contact with part of the floor on which the scales are standing.

In other cases, it is time-consuming and inconvenient to weigh the item of luggage with the bathroom scales, e.g. in the case of the school satchel, because the weight of the school satchel has to be determined again every morning and it has to be taken to a bathroom for this purpose, which is where the bathroom scales are kept, as a rule.

The invention is therefore based on the problem of weighing an item of luggage quickly and easily.

### BRIEF SUMMARY OF THE INVENTION

This problem is solved in accordance with the invention in that the item of luggage is characterised by the provision of scales with an associated weight outputting means for outputting the weight thereof.

The scales preferably have a load-bearing part, which is rigidly joined to the item of luggage, and a free slide, which can be displaced relative to the item of luggage.

The scales are preferably electronic scales.

Alternatively, the scales are mechanical scales.

In an advantageous embodiment, the scales are a hanging dynamometer.

In this case, the free slide of the hanging dynamometer is preferably retained on the item of luggage by means of a removable retaining means.

In this case, the free slide of the hanging dynamometer preferably takes the form of a handle of the item of luggage.

In a further embodiment, the scales take the form of a pressure balance, so that the free slide is formed by at least one foot.

In both embodiments, there is preferably a locking means associated with the scales such that the free slide of the scales is rigidly joined to the item of luggage in a locked state, so that there is no load on the scales, and the free slide of the scales is slidably joined to the item of luggage in a non-locked state, in order to subject the scales to the weight of the item of luggage.

The weight outputting means is preferably an electric display and/or a mechanical display or/ and a voice output device for outputting the weight.

The scales advantageously include a zero adjustment means for adjusting the zero point of the scales.

The item of luggage is advantageously a holdall, bag, suitcase, school satchel, knapsack, sack, briefcase, portfolio or rucksack.

### BRIEF DESCRIPTION OF THE DRAWINGS

The invention will be described in the following by considering four practical embodiments, reference being made to a drawing, in which:

FIG. 1 shows a front view of an item of luggage with two associated scales in accordance with the present invention in a first embodiment, the scales being formed as mechanical scales;

FIG. 2 shows an enlarged view of the scales of FIG. 1;

FIG. 3 shows a view of the scales of FIG. 2 in which the scale is not illustrated, in order to illustrate an internal structure of the scales;

FIG. 4 shows an item of luggage with associated scales in accordance with the present invention in a second embodiment, in which the scales are formed as electronic scales;

FIG. 5 shows a wiring circuit of the electronic scales of FIG. 4;

FIG. 6 shows an item of luggage with associated scales in accordance with the present invention in a third embodiment, the scales being formed as mechanical scales; and

FIG. 7 shows an item of luggage with associated scales in accordance with the present invention in a fourth embodiment.

### DETAILED DESCRIPTION OF THE INVENTION

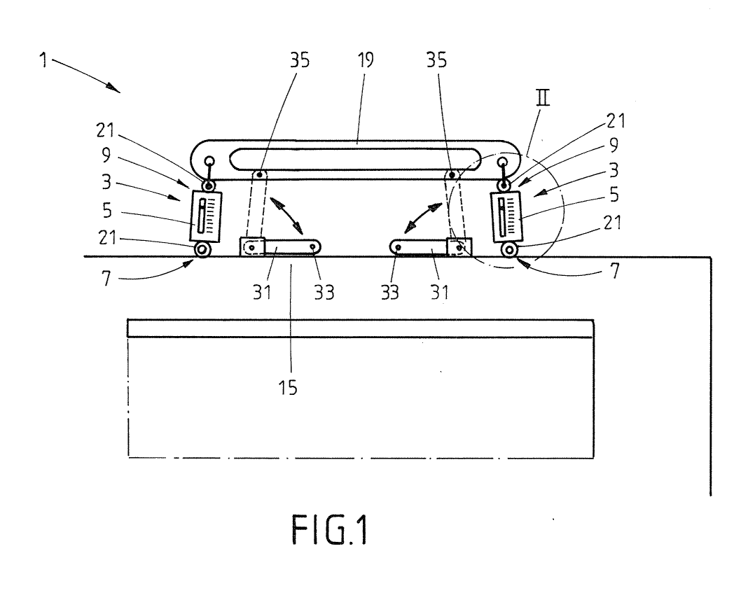

Referring to FIGS. 1, 2 and 3, a first embodiment of the present invention is described next.

An item of luggage 1 in FIG. 1 includes two structurally identical mechanical scales 3, each of which is attached at one end to the item of luggage 1 and at the other end to a handle 19 of the item of luggage 1 (hanging dynamometers).

As illustrated in FIG. 1, the scales 3 are joined to the handle 19, or the item of luggage 1, at each of their ends by means of an eye 21, so that the handle 19 can be pivoted relative to the item of luggage 1.

Each of the scales 3 includes a load-bearing part 7, which is rigidly joined to the item of luggage 1. Via the load-bearing part(s) 7, the weight of the item of luggage 1 is applied to the scales 3.

Each of the scales 3 further includes a free slide 9, which is displaced relative to the load-bearing part 7 in accordance with the weight of the item of luggage 1 when the item of luggage 1 is weighed with the scales 3.

Each of the scales 3 further includes a weight outputting means 5, in this case a mechanical scale, in order to display the weight of the item of luggage 1 measured with the scales 3.

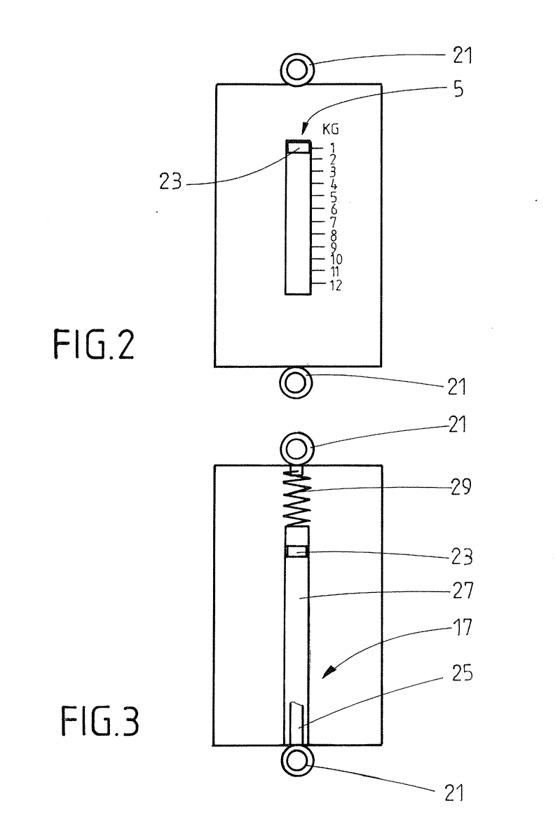

FIG. 2 shows the weight outputting means 5, i.e. the mechanical scale of the scales 3, in an enlarged view. The weight outputting means 5 has a scale in kilograms, and the weight measured with the scales 3 can be read off on that scale with the aid of the marking 23.

FIG. 3 shows an internal structure of the scales 3 of FIG. 2.

Attached to the lower eye 21 in FIG. 3 (load-bearing part 7) is a screw 25, which is screwed into a measuring rod 27 with an internal thread. The marking 23 for displaying the weight measured with the scales 3 is provided on the measuring rod 27.

At the upper end in FIG. 3, the measuring rod 27 is connected to the upper eye 21 in FIG. 3 (free slide 9) by means of a spiral spring 29.

When the item of luggage 1 is lifted by the handle 19, a force, namely the weight of the item of luggage 1, acts downwards (orientation as in FIG. 1) on the load-bearing parts 7, as a result of which the spiral springs 29 of the two scales 3 are stretched according to the amount of the weight being applied.

The respective marking 23 of the scales 3 moves downwards relative to the weight outputting means 5 (the scale) in accordance with the stretching of the spiral springs 29, so that the weight measured can be read off on each of the scales 3.

Since the weight of the item of luggage 1 in the present case is measured with two scales 3, the weights measured by each of the scales 3 need to be added in order to obtain the total weight of the item of luggage 1.

Each of the scales 3 also includes a zero adjustment means 17, in order to adjust the zero point of the scales 3. The zero adjustment means 17 in this case is formed by allowing the measuring rod 27 to be rotatable relative to the screw 25, as a result of which the marking 23 on the measuring rod 27 can be displaced upwards and downwards (orientation as in FIG. 3) relative to the load-bearing part 7.

If the item of luggage 1 with the arrangement described so far were to be carried by a person holding the handle 19, the spiral springs 29 would be constantly subjected to the weight of the item of luggage 1 and would quickly lose their elastic behaviour, so that the associated scales 3 would no longer work appropriately. For this reason, a locking means 15 is provided, by which the item of luggage 1 can be connected to the handle 19, so that the weight of the item of luggage 1 is applied to the handle 19 via the locking means 15, as a consequence of which, no load is applied to the spiral springs 29 of the scales 3. At the same time, however, the locking means 15 can be adjusted in such a way that it does not include any connection between the item of luggage 1 and the handle 19, so that the entire weight of the item of luggage 1 is applied to the handle 19 via the scales 3.

The locking means 15 in the present case includes two supporting members 31, each of which is pivotably mounted at one end to the item of luggage 1 and has an aperture 33 in the other end, so that that end can be snapped onto a pin 35 formed on the handle 19.

The supporting members 31 are shown in FIG. 1 firstly in engagement with the handle 19 (dashed line) and secondly separated from the handle 19 (unbroken line). The dashed illustration of the supporting members 31 thus corresponds to the locked state of the locking means 15, and the unbroken illustration of the supporting members 31 corresponds to the non-locked state of the locking means 15.

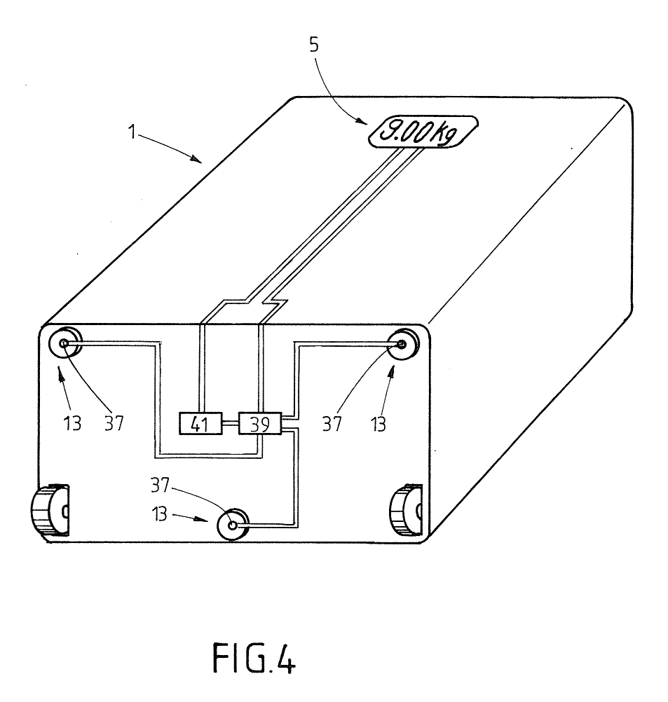

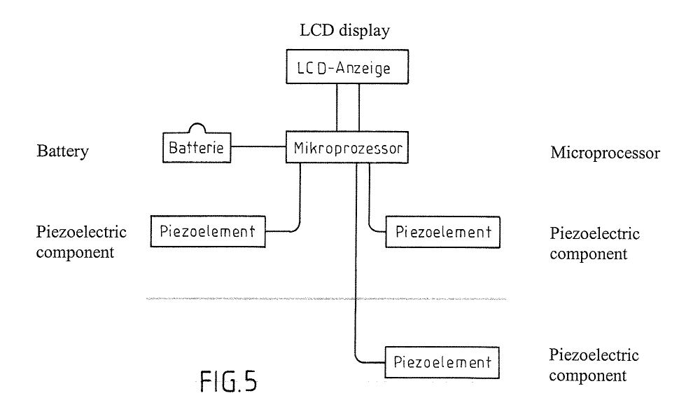

Referring to FIGS. 4 and 5, a second embodiment of the item of luggage 1 with associated scales 3 is described next.

The scales 3 of the second embodiment are electronic scales and comprise a weight outputting means 5 in the form of an LCD display and three piezoelectric components 37, which are known from conventional electronic scales, one of which in each case is disposed in a foot 13 of the item of luggage 1.

The scales 3 further include a microprocessor 39, which is connected to the piezoelectric components 37 and the weight outputting means 5. In addition, the scales 3 include a battery 41 for supplying current to the microprocessor 39 and the weight outputting means 5.

When the item of luggage 1 is standing on the three feet 13, so that the entire weight of the item of luggage 1 is resting on the three feet (pressure balance), the microprocessor 39 receives from each piezoelectric component 37 a voltage that corresponds to the weight measured with the piezoelectric component 37 at that particular time. The microprocessor 39 converts the voltage supplied by each piezoelectric component 37 into a corresponding weight value and adds the three weight values received in this way (from each piezoelectric component) into a total weight of the item of luggage 1.

The total weight of the item of luggage 1 obtained in this way is issued by the microprocessor 39 to the weight outputting means 5, which displays the total weight of the item of luggage 1.

The electronic scales 3 can be switched on and off by a switch (not shown).

In an alternative embodiment, the scales 3 are activated for a predetermined period of time, 30 seconds for example, by a non-locking key disposed in a foot 13. In this embodiment the scales 3 are thus always activated for that period of time whenever the non-locking key is switched on, i.e. when the item of luggage 1 is placed down on the feet 13.

Instead of a battery 41, the scales 3 may include a solar cell for supplying current to the electronic scales 3.

In this embodiment, the scales 3 do not include locking means 15, since the piezoelectric components 37 are very low-wear, or indeed wear-free.

The scales 3 can be switchable between two display modes, so that the scales 3 display the total weight of the item of luggage 1 in a first display mode and the weight of the articles contained in the item of luggage 1 in a second display mode, i.e. the total weight of the item of luggage 1 minus the weight of the item of luggage 1 itself. The weight of the item of luggage 1 itself can be stored in a memory of the microprocessor 39.

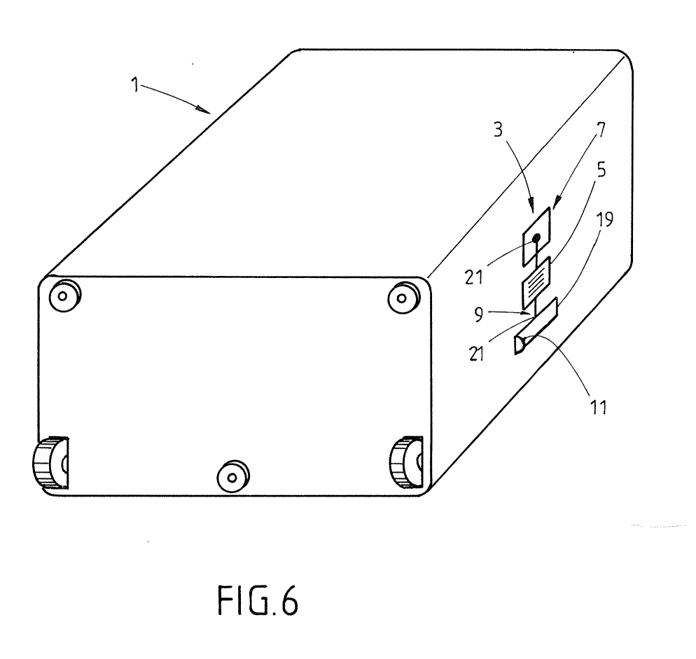

Referring to FIG. 6, a third embodiment of the item of luggage 1 with scales 3 is described next.

The item of luggage 1 comprises scales 3, of the kind described earlier in connection with the first embodiment, i.e. with a load-bearing part 7 and a free slide 9, which passes over into a handle 19.

The item of luggage 1 can be picked up by the handle 19 in order to read off the weight of the item of luggage 1 on the weight outputting means 5.

When the scales 3 are not needed, the handle 19 can be fixed to the item of luggage 1 by a retaining means 11, so that the handle 19 is not freely movable. The retaining means 19 can take the form of a snap lock, a tab, a Velcro closure or the like.

In a preferred version of this embodiment, the scales 3 are disposed in an interior space of the item of luggage 1, such as in an additional pocket formed in the item of luggage 1. The scales 3 are in this case not visible from the outside, so that they cannot be felt to be disturbing.

In the practical embodiments described so far, the item of luggage 1 is closed when its weight is measured with the associated scales 3.

It may, however, be advantageous to measure the weight of the item of luggage 1 with the associated scales 3 when the item of luggage 1 is open, such as in the situation where the item of luggage 1 is a suitcase which is being packed for a flight.

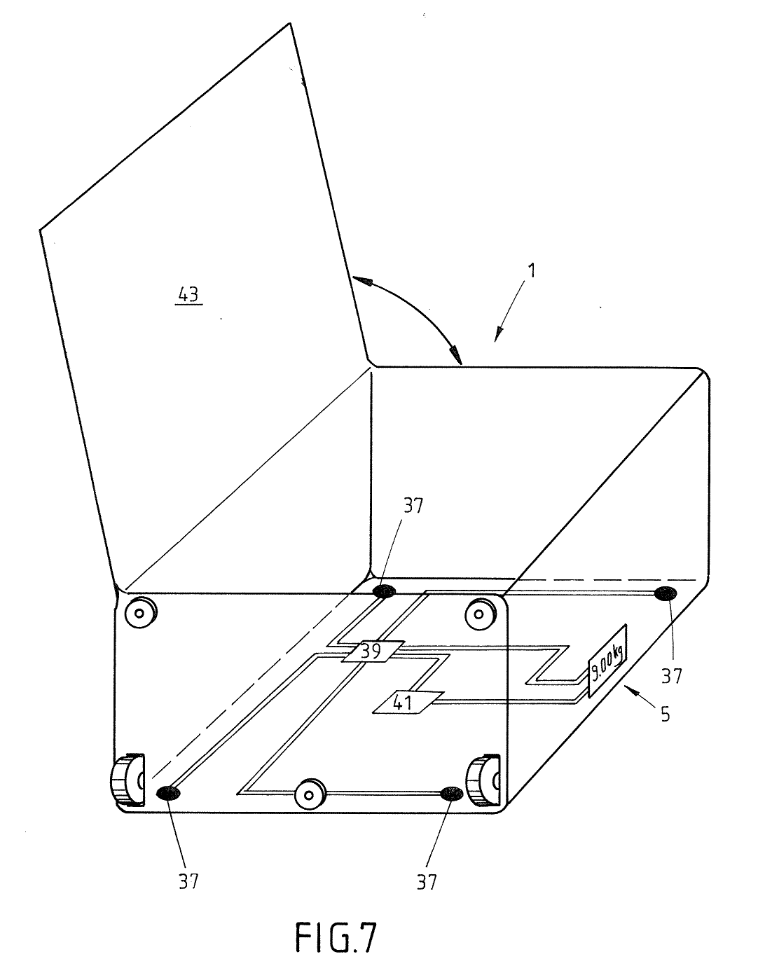

FIG. 7 shows a fourth embodiment of an item of luggage 1 with associated scales 3 and the weight of the item of luggage 1 being measured while it is open. The item of luggage 1 is a suitcase in this embodiment, the lid 43 of which is open in order to place clothes, for example, in it.

As described earlier in connection with FIG. 4, the item of luggage 1 includes piezoelectric components 37, a microprocessor 39, a battery 41 and a display 5, in order to measure and display the weight of the item of luggage 1.

The scales 3 can switched on and off by opening and closing the lid 43.

The item of luggage 1 shown in FIG. 7 can additionally include the three piezoelectric components 37 which are shown in FIG. 4, in which case these are likewise connected to the microprocessor 39 (in FIG. 7). In this variant, the microprocessor 39 is arranged in such a way that it either processes and displays the values from the four piezoelectric components 37 (FIG. 7) or from the three piezoelectric components 37 (FIG. 4), depending on whether values from all four piezoelectric components 37 (FIG. 7) or all three piezoelectric components 37 (FIG. 4) are present.

In general, this means that first scales and second scales can thus be assigned to each item of luggage, the first scales measuring the weight of the item of luggage when it adopts a first position, for example when it is lying down (FIG. 7), and the second scales measuring the weight of the item of luggage when it adopts a second position, for example when it is standing (FIG. 4).

The scales 3 in the embodiments described above include at least one spring as the measuring member, such as the spiral springs 29 in FIGS. 1, 2 and 3, or at least one piezoelectric component, such as the piezoelectric components 37 in FIGS. 4 and 5. As the measuring member, the scales 3 may alternatively comprise any suitable measuring member, such as a hydraulic fluid or a bimetal strip.

1. An item of luggage, comprising: with an associated weight outputting means for outputting the weight of the luggage, wherein the scales are attached to the luggage.

2. The item of luggage as claimed in claim 1, wherein the scales have a load-bearing part, which is rigidly joined to the item of luggage, and a free slide, which can be displaced relative to the item of luggage.

3. The item of luggage as claimed in claim 1, wherein the scales are electronic scales.

4. The item of luggage as claimed in claim 1, wherein the scales are mechanical scales.

5. The item of luggage as claimed in claim 1, wherein the scales are a hanging dynamometer.

6. The item of luggage as claimed in claim 5, wherein the free slide of the hanging dynamometer is retained on the item of luggage by means of a removable retaining means.

7. The item of luggage as claimed in claim 5, wherein the free slide of the hanging dynamometer takes the form of a handle of the item of luggage.

8. The item of luggage as claimed in claim 1, wherein the scales are a pressure balance, so that the free slide is formed by at least one foot.

9. The item of luggage as claimed in claims 1, wherein a locking means is associated with the scales in such a way that the free slide of the scales is rigidly joined to the item of luggage in a locked state, so that there is no load on the scales, and the free slide of the scales is slidably joined to the item of luggage in a non-locked state, in order to subject the scales to the weight of the item of luggage.

10. The item of luggage as claimed in claim 1, wherein the weight outputting means is selected from a group consisting of an electric display, a mechanical display and a voice output device for outputting the weight.

11. The item of luggage as claimed in claim 1, wherein the scales include a zero adjustment means in order to adjust the zero point of the scales.

12. The item of luggage as claimed in claim 1, wherein the luggage is selected from a group consisting of a holdall, bag, suitcase, school satchel, knapsack, sack, briefcase, portfolio and rucksack.
